(19) United States
(12) Patent Application Publication
(10) Pub. No.: US 2015/0254720 A1
(43) Pub. Date: Sep. 10, 2015

(54) LOCATION-BASED DIRECTED PRODUCT AND SERVICE SUGGESTIONS

(71) Applicant: Cubic Corporation, San Diego, CA (US)

(72) Inventors: Ian Newberg, Derwood, MD (US); Thomas Noyes, Gaithersburg, MD (US); Mohsen Fahim, Danville, CA (US)

(21) Appl. No.: 14/640,971

(22) Filed: Mar. 6, 2015

Related U.S. Application Data
(60) Provisional application No. 61/949,141, filed on Mar. 6, 2014.

(51) Int. Cl. G06Q 30/02

(52) U.S. Cl. CPC G06Q 30/0265; G06Q 30/0267; G06Q 30/0269

(57) ABSTRACT

A method for providing real-time location-based advertising within a transit system includes receiving origin information and destination information related to a user's trip using the transit system. The method includes receiving device location information from a mobile device and vehicle location information from a transit vehicle. The device location information includes a location of the mobile device, and the vehicle location information includes a location of the transit vehicle. The method includes matching an advertisement profile with one or more of the device location information, the vehicle location information, the original information, or the destination information to identify an advertisement. The method includes causing a display of a remote device to reproduce an electronic version of the identified advertisement and providing real-time arrival time information to the user's mobile device. The real-time arrival time information is based on the vehicle location and the destination information.

### CROSS-REFERENCES TO RELATED APPLICATIONS

This application claims priority to U.S. Provisional Patent Application No. 61/949,141 filed Mar. 6, 2015, entitled “LOCATION-BASED DIRECTED ADVERTISING,” the entire disclosure of which is hereby incorporated by reference, for all purposes, as if fully set forth herein.

### BACKGROUND OF THE INVENTION

As mobile devices have become more of a fixture within society, advertisers have begun using mobile device displays as a medium through which to provide advertising content. Traditional advertisement systems may utilize a user's location, as provided by data from the mobile device, to provide targeted product and service suggestions for local goods and services. However, such systems fail to provide relevant advertisements to riders of transit systems, as a user may be provided an advertisement for a business or service that a rider may not easily access due to the placement of transit stops and/or based on a user's destination.

### BRIEF SUMMARY OF THE INVENTION

Embodiments provide systems to match advertisements with users of mobile devices who utilize transit systems based on origins and destinations of transit trips. The systems take into account the final destination of the user and/or any transit stops or transfer locations where a user may be headed to select advertisements to provide to the user. The systems may also take into account demographic information about the users to provide better targeted advertising to the users' mobile devices. Advertisements may also be provided to electronic billboards and/or transit vehicle signage based on the location of the vehicle and the demographics of any riders. In this way, advertisements may be delivered to a recipient that are relevant and useful, based on the next location they will be at outside of the transit system. Embodiments also provide real-time arrival estimations of transit vehicles at destinations, transfer stops, and/or other transit stops. This enables the user to better plan trips using the transit system.

In one aspect, a method for providing real-time location-based advertising within a transit system is provided. The method may include receiving origin information and destination information. Both the origin information and the destination information may be related to a user's trip using the transit system. The method may also include receiving device location information from a mobile device and vehicle location information from a transit vehicle. The device location information may include a location of the mobile device, and the vehicle location information may include a location of the transit vehicle. The method may further include matching an advertisement profile that has been received from an advertisement agency with one or more of the device location information, the vehicle location information, the origin information, or the destination information to identify an advertisement. The method may also include causing a display of a remote device to reproduce an electronic version of the identified advertisement and providing real-time arrival time information to the user's mobile device. The real-time arrival time information may be based at least in part on the vehicle location information and the destination information.

In another aspect, a non-transitory computer-readable medium having instructions embedded thereon for providing real-time location-based advertising within a transit system is provided. The instructions may include computer code for causing a computing device to receive origin information and destination information. Both the origin information and the destination information may be related to a user's trip using the transit system. The instructions may also include computer code for causing a computing device to receive device location information from a mobile device and vehicle location information from a transit vehicle. The device location information may include a location of the mobile device, and the vehicle location information may include a location of the transit vehicle. The instructions may further include computer code for causing a computing device to match an advertisement profile that has been received from an advertisement agency with one or more of the device location information, the vehicle location information, the origin information, or the destination information to identify an advertisement. The instructions may also include computer code for causing a computing device to cause a display of a remote device to reproduce an electronic version of the identified advertisement and to provide real-time arrival time information to the user's mobile device. The real-time arrival time information may be based at least in part on the vehicle location information and the destination information.

In another aspect, a system for providing real-time location-based advertising within a transit system may be provided. The system may include a communications interface configured to send and receive data, a memory, and a processor. The processor may be configured to receive origin information and destination information. Both the origin information and the destination information may be related to a user's trip using the transit system. The processor may also be configured to receive device location information from a mobile device and vehicle location information from a transit vehicle. The device location information may include a location of the mobile device, and the vehicle location information may include a location of the transit vehicle. The processor may be further configured to match an advertisement profile that has been received from an advertisement agency with one or more of the device location information, the vehicle location information, the original information, or the destination information to identify an advertisement. The processor may also be configured to cause a display of a remote device to reproduce an electronic version of the identified advertisement and to provide real-time arrival time information to the user's mobile device. The real-time arrival time information may be based at least in part on the vehicle location information and the destination information.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a system diagram showing a system for providing real-time location-based advertising within a transit system according to embodiments.

FIG. 2 depicts a system for determining the location of a transit vehicle according to embodiments.

FIG. 3 is a swimlane diagram depicting communications between components of a system for providing real-time location-based advertising within a transit system according to embodiments.

FIG. 4 is a flowchart depicting a process for providing real-time location-based advertising within a transit system according to embodiments.

FIG. 5 is a block diagram of an example computing system according to embodiments.

### DETAILED DESCRIPTION OF THE INVENTION

For the purposes of explanation, the ensuing description provides specific details that are set forth in order to provide a thorough understanding of various embodiments. It will be apparent, however, to one skilled in the art that various embodiments may be practiced without some of these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments. In other instances, well-known structures and devices are shown in block diagram form.

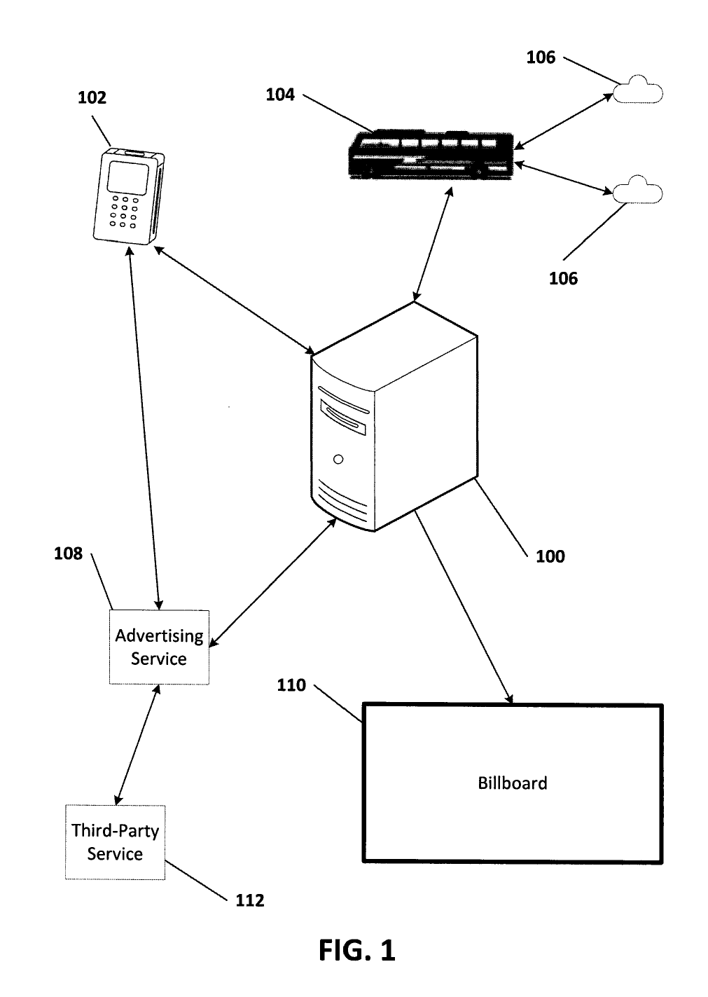

Referring now to FIG. 1, a system for providing real-time location-based product and service suggestions within a transit system is shown. Product and service suggestions may include advertisements, such as advertisements for nearby businesses. The system may include a transit server 100 that is connected to the various other components of the system using one or more networks, such as cellular communications networks, wide area networks (WAN), local area networks (LAN), as well as any other networks providing wired and/or wireless data communication. Transit server 100 may be in communication with mobile devices, such as mobile device 102. Mobile device 102 may be a cellular phone, smartcard, tablet computer, or other portable electronic device configured to communicate over a network. In some embodiments, the mobile device 102 may communicate location information to the transit server 100. The location information may be determined by a GPS sensor of the mobile device 102 and may be used by the transit server 100 to help match the user with an advertisement profile.

The mobile device 102 may also provide origin and destination information related to a transit trip. For example, during trip planning and/or the purchase of transit fare, a user may identify when and/or where the transit trip is to begin. As one example, a user may enter a bus stop identifier (ID) or a street intersection into the mobile device 102, such as using a transit website or mobile transit application, to provide origin and destination information. In some embodiments, a mobile transit application may include a drill down/drop down menu that helps a user to find an origin and destination transit stop if the name and/or street intersections are unknown. The mobile transit application may also provide a list of transit stops that are nearby using the GPS data from the mobile device 102. The origin and destination information may be used by the transit server 100 to calculate arrival times and drop off times. This information may also be used as criteria to help match advertisement profiles to determine which advertisement to provide a user. It will be appreciated that the provision of origin and destination information may be provided by other computing devices, rather than the mobile device 102. For example, a transit kiosk or other point of sale device may be used to select origin and destination information, which may then be sent to the transit server 100. As another example, the origin may be received by scanning a barcode or other image near a transit stop. Mobile device 102 may scan the image, such as a barcode on a sign, and receive a location of the origin.

The transit server 100 may also be communicatively coupled with a transit vehicle 104. The transit vehicle 104 may be a bus, a train, a subway, a taxi, or any other vehicle. The transit vehicle 104 may provide its location to the transit server 100. For example, the transit vehicle 104 may include a GPS sensor and transit data from the GPS sensor to the transit server 100. In other embodiments, the transit vehicle 104 may wirelessly communicate with a number of beacons 106 positioned around a transit system. Based on which beacons 106 the transit vehicle 104 communicates with, along with the signal strength of the communications, the location of the transit vehicle 104 may be determined. The location, as determined by interactions with the beacons 106, may be provided to the transit server 100.

A third-party advertising service 108 may be communicatively coupled with the transit server 100. The advertising service 108 may provide a number of advertising profiles and associated advertisements to the transit server 100. Each advertisement profile may include a set of criteria, such as location information, origin and/or destination information, demographic information, and other data that may be used to provide targeted advertisements to individuals. For example, an advertisement may be provided to a user based on the user's current location, the transit destination, and/or their demographic information. The advertisement profiles may be received prior to the reception of the original and/or destination information and stored in a database of the transit server 100. The transit server 100 may then lookup the stored advertisement profiles upon receipt of the information. When the received information or characteristics match characteristics identified by an advertisement profile, a corresponding advertisement is selected and provided to a remote device for publication. For example, each of the criteria, or data received from a user and/or transit vehicle, may be associated with an identifier, such as an alphanumeric code. Each of the advertisement profiles may be indexed according to one or more characteristics or criteria associated with the advertisement profile. The transit server 100 may then quickly match the identifiers with the indexed advertisement profiles to identify a relevant advertisement. By matching identifiers with indexed advertisement profiles, a processing unit of the transit server 100 may more quickly and efficiently identify relevant advertisements and provide them to remote devices. Remote devices may include the user's mobile device 102, an electronic sign of the transit vehicle 104, and/or an electronic billboard 110. In some embodiments, the transit server 100 may first receive origin, destination, demographic, location, and/or other data and then poll the advertising service 108 for an advertising profile matching this information.

In some embodiments, the advertisement profiles may be maintained by the advertising service 108, and may be provided to the transit server 100, along with a set of advertisements associated with each of the advertisement profiles. As the transit server 100 receives the location, origin and destination information, and/or demographic information, the transit server 100 may match this received information with one or more advertisement profiles to determine an appropriate advertisement to provide to a user or set of users. The advertisements may correspond to businesses at the user's selected destination, businesses positioned somewhere along the transit route to the user's destination, and/or businesses positioned near transfer locations on the transit route. The matching of advertising profiles may be done to ensure a relevant advertisement may be provided to the user at each step along a trip.

In some embodiments, the advertisement may be provided to a user's mobile device 102, such as by providing a banner advertisement on a webpage or within a mobile application associated with the transit system. For example, a mobile transit application may allow for trip planning, the purchase of transit fare, and/or real-time transit vehicle arrival information. In other embodiments, an advertisement may be provided for display on an electronic billboard 110, such as a billboard near a rail track or a bus route. The billboard 110 may be visible by riders of the transit vehicle 104. The advertisement may also be provided to one or more electronic signs provided on the transit vehicle 104. For example, an interior of the transit vehicle 104 may include signs, transit maps, and/or city maps. Advertisements may be displayed on these signs and/or maps. The advertisements are often provided while a user is in transit between a first transit stop and a second transit stop.

In some embodiments, a transit vehicle 104 may include external signs, such as those on the exterior of buses. Information, such as the location of the transit vehicle 104, the location information of the users of mobile devices 102, origin information and/or demographic information may be used to determine an advertisement to display on a side of a transit vehicle 104. For example, an 18 year old male transit user may be waiting at a transit stop for his bus to arrive. The user's mobile device 102 may transmit his demographic and/or location information to the transit server 100, which may then match this information to an advertisement profile. The transit server 100 may then cause an advertisement corresponding to the advertisement profile to be displayed on the bus such that the user may see the advertisement prior to boarding the bus.

In embodiments where an advertisement will be visible to multiple people, such as billboard 110, the transit server 100 may detect demographic, location, origin, and/or destination information from multiple people, as well as location information from the transit vehicle 104. The transit server 100 may then match this information with an advertisement profile by determining a most common demographic present on the transit vehicle 104 and/or by determining a most profitable demographic to use for the matching of the advertisement profile. For example, the most common rider may be women ages 30-45, so the advertisement profile may match this demographic. If, on the other hand, it is determined the most likely demographic to spend money based on seeing an advertisement is males 18-25, then the advertisement profile may be matched with this demographic. Various rules may be put in place by the transit server 100 and/or the advertising service 108 to determine how advertisement profiles are matched in cases of signs visible to multiple users.

In some embodiments, demographic information may be received from the user's mobile device 102, such as by the user registering with the transit system and/or by registering with a mobile transit application, such as an application that provides the user with real-time arrival information for transit vehicles. The demographic information may also or alternatively be provided by one or more third-party services 112. For example, a user may have an account with a third-party service 112 like a social media provider. The user may link this account to a transit account or mobile transit application account, such as by registering for the mobile transit application using the user's social media account credentials. As one example, a user's Facebook™ account may be used to register with the mobile transit account. The third-party service 112 may then provide the transit server 100 with demographic information about the user.

In some embodiments, the third-party services 112 may take advantage of the association with the transit server 100 and/or a mobile transit application by receiving transit usage data, advertisement and advertisement click data, and/or other information received from the transit server 100 and/or mobile transit application. The third-party services 112 may then use this data for their own business and marketing purposes. As one example, the third-party services 112 may build their own websites and/or mobile applications that make use of this data. An application programming interface (API) may be provided to the third-party services 112 such that the data may be easily integrated into their mobile applications. As another example, the advertising service 108 may also utilize this information to further develop advertisements and advertisement profiles that may be more effective and more likely to reach their intended audiences. For example, an advertisement service 108 may track any screen clicks of advertisements produced on the screen of mobile devices 102. This allows the advertisement service 108 to collect information related to the type of person looking at the advertisements. The advertisements may also include coupons, coupon codes, and or other discounts to further encourage users to utilize various businesses. Such discounts may include promotional identifiers that may be tracked when redeemed. Advertising services 108 may then use the tracked promotional identifiers to evaluate the effectiveness of the advertisements.

In some embodiments, the transit server 100 may provide real-time location and/or arrival information of the transit vehicle 104 to the user of the mobile device 102. For example, the transit server 100 may include vehicle tracking information and or schedules featuring real-time arrival updates to a website and/or mobile transit application. The user may access this information to help with trip planning and/or in knowing when the transit vehicle 104 will arrive to pick them up and/or drop them off at their destination. In some embodiments, the real-time location information may be paired with real-time and/or historical traffic information. The combination of traffic information and location information may allow for better predictions of arrivals of transit vehicles 104. The traffic information may be collected using the transit server 100 and/or may be received from a third party service.

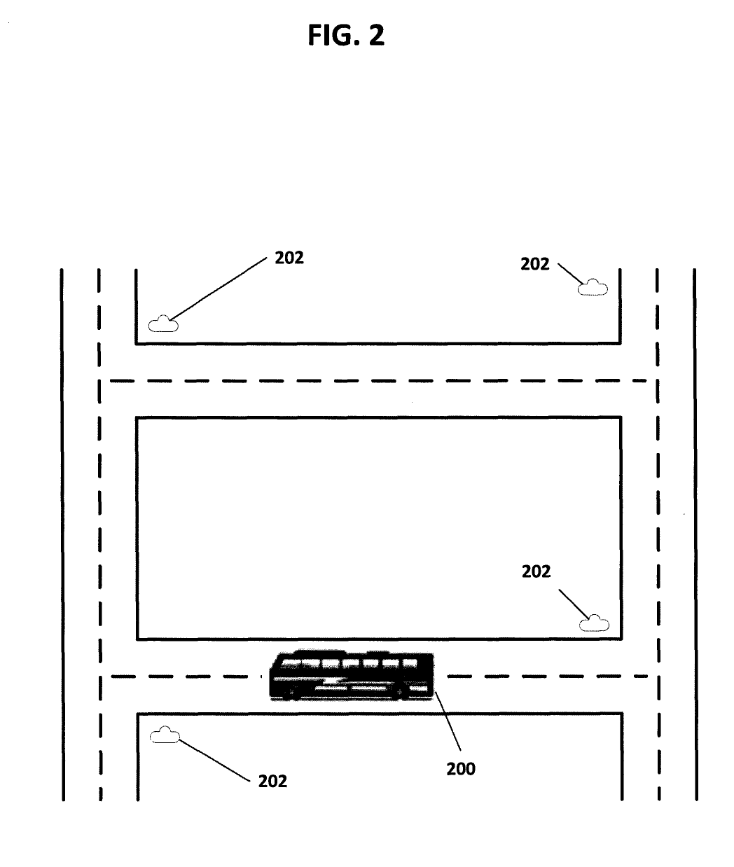

FIG. 2 depicts a transit vehicle 200 and a number of stationary beacons 202. The transit vehicle 200 and beacons 202 may correspond with transit vehicle 104 and beacons 106 described in FIG. 1. Beacons 202 may be positioned along a transit route, such as a bus route and/or light rail tracks. The transit vehicle 200 may communicate with one or more of the beacons 202, and based on the location of the signals from the beacons 202 as well as the signal strength of the communications with each of the beacons 202, a location of the transit vehicle 200 may be determined. For example, each of the beacons 202 may have a communications radius such that when a transit vehicle 200 is within the radius, a communication may take place. By determining which of the beacons 202 the transit vehicle 200 is in communication with, a general location of the transit vehicle 200 may be determined.

Using the information from the interaction with the beacons 202, as well as by using data from any GPS sensors on the transit vehicle 200, a location of the transit vehicle may be determined. This location may be used by a transit server, such as transit server 100 described above, as criteria with which to match an advertisement profile. The location information may also be used to determine a real-time estimated arrival time of the transit vehicle 200 at a transit stop, arrival location, and/or destination. This arrival information may be used in travel planning and/or may be provided to a user to help determine when the user's transit vehicle 200 will arrive. The real-time location information is also very useful in matching advertisement profiles, as durations of transit stops and/or transfer location stops may be calculated, and advertisement profiles may be skipped if there is not sufficient time for a stop near the advertised business. Conversely, if the transit vehicle 200 is ahead of schedule and a transit vehicle 200 will be stopped longer than expected, an advertisement profile may be matched such that an advertisement for a business near the transit stop is provided. For example, if the duration of the transit stop is short, such as ten to fifteen minutes, the matching advertisement profile may correspond to an ad for a coffee shop or similar service. If the duration of the transit stop is long, such as an hour or two for a transfer to another line of the transit system, the advertisement profile may correspond to a shop or restaurant. The location determined by the beacons 202 may help determine when an advertisement should switch. For example, when the location is determined to be past a certain transit stop or other point, a first advertisement associated with a business already passed may be removed and a second advertisement associated with the next transit stop and/or the user's destination may be provided.

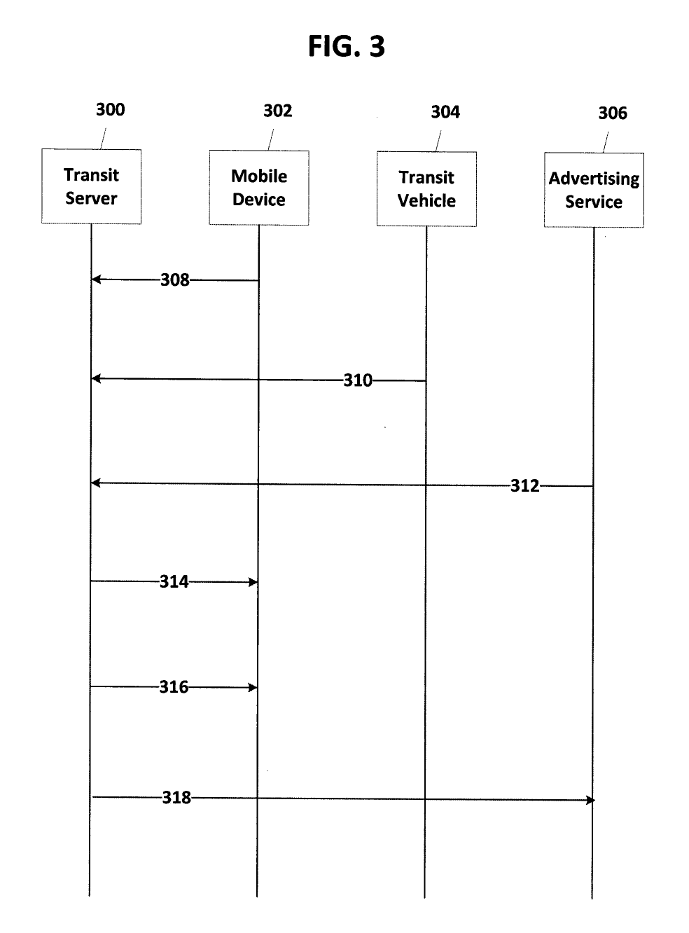

FIG. 3 shows a swimlane diagram of the interaction of a transit system or other transit server 300, a mobile device 302, a transit vehicle 304, and an advertising service 306. The transit server 300, a mobile device 302, a transit vehicle 304, and an advertising service 306 may correspond to the transit server 100, mobile device 102, transit vehicle 104, and advertising service 108 as described in relation to FIG. 1. The mobile device 302 may provide a first communication 308 to the transit server 300. The first communication 308 may include origin and/or destination information of the user of the mobile device 302. In some embodiments, the first communication 308 may also include demographic, real-time location, and/or other information related to the user that may be useful in matching an advertising profile with a user. The transit vehicle 304 may transmit a second communication 310 to the transit server 300. The second communication 310 may include real-time location information of the transit vehicle 304.

The advertising service 306 may provide a third communication 312 including one or more advertisement profiles and corresponding advertisements to transit server 300. In some embodiments, the third communication 312 may be received by the transit server 300 prior to reception of the first and second communications 308 and 310, while in other embodiments, the third communication 312 may be received upon a request from the transit server 300 after having received the first and/or second communications 308 and 310. The transit server 300 may match an advertisement profile based on the information received in the first and/or the second communication 308 and 310. Once an advertisement is determined based on the matched advertisement profile, the transit server 300 may send a fourth communication 314 to the mobile device 302. The fourth communication 314 may cause a display of the mobile device 302 to reproduce an electronic version of the advertisement. In some embodiments, the fourth communication 314 may be transmitted to an electronic billboard and/or an electronic sign of the transit vehicle 304. The transit server 300 may also provide a fifth communication 316 to the mobile device 302. The fifth communication 316 may include real-time arrival information for the transit vehicle 304. This real-time information may help a user plan a trip and/or know when they can expect to be picked up or dropped off by the transit vehicle 304. A sixth communication 318 may be sent from the transit server to the advertising service. The sixth communication may include data related to the effectiveness of advertisements, such as whether an advertisement was clicked and/or whether coupon codes were redeemed. It will be appreciated that the communications shown in the swimlane diagram may be provided in any number of sequences.

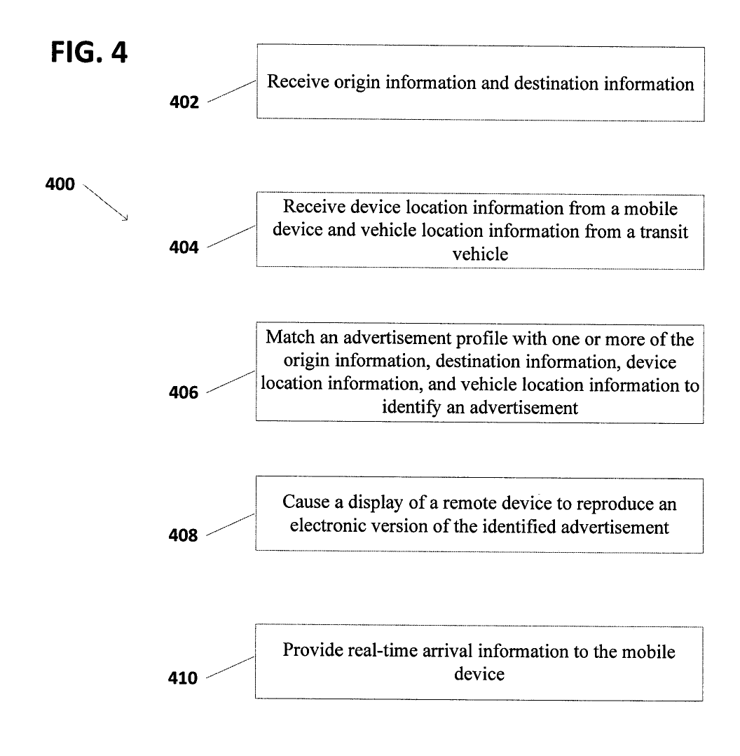

FIG. 4 depicts a process 400 for providing real-time location-based advertising within a transit system. Process 400 may be performed by a transit server, such as transit servers 100 and 300 described herein, or by other computing devices. At block 402, origin information and destination information may be received. For example, the origin and destination may be received from a user's mobile device, a kiosk, and/or other computing device communicatively coupled with the transit server. The information may be received as part of trip planning and/or purchase of transit fare. Both the origin information and the destination information may be related to a user's trip using the transit system. The process 400 may include receiving device location information from a mobile device and vehicle location information from a transit vehicle at block 404. The device location information may include a location of the mobile device, and the vehicle location information may include a location of the transit vehicle. The location of the mobile device may be detected by a GPS sensor of the mobile device. Data from the GPS sensor may be communicated to the transit server. The location of the transit vehicle may be determine by a GPS sensor of the transit vehicle, by using signals communicated with beacons as described in relation to FIG. 2, and/or by a combination of GPS and beacon data. This vehicle location information may also be transmitted to the transit server. In some embodiments, demographic information may be received related to a user of the mobile device. For example, the demographic information may include a name, residence, age, gender, and/or other information related to the user. The demographic information may be received from the mobile device and/or through a third party. For example, the user may provide demographic information as part of a registration process for a transit system, such as by registering to receive real-time arrival information. The demographic information may also be received from a third-party, such as a social media account associated with the user of the mobile device. A social media account may be linked to an account within the transit system to provide the demographic information. Such demographic information may be used to provide more properly targeted advertisements.

At block 406, an advertisement profile that has been received from an advertisement agency may be matched with one or more of the device location information, the vehicle location information, the original information, or the destination information to identify an advertisement. In embodiments where demographic information has been collected, the demographic information may also be used to help match an advertisement profile. The process 400 may further include causing a display of a remote device to reproduce an electronic version of the identified advertisement at block 408. For example, advertisement may be displayed on the mobile device, an electronic billboard, and/or signage of the transit vehicle. In some embodiments, the process 400 may include detecting a next transit stop and detecting a duration of the stop at the next transit stop. The next transit stop and the duration of the stop may be matched to the advertisement profile. This enables an advertisement related to a business or service located near the stop to be provided to the user. For example, if the duration of the stop is 15 minutes, an advertisement for a quick serving business, such as a coffee shop, may be provided. A coupon or other discount may be provided along with or as part of the advertisement to further encourage the user to visit the business. In some embodiments, a coupon may be provided to a user's mobile device by sending an email, short messaging service (SMS) message, and/or a push notification from a mobile transit application on the mobile device.

By detecting next transit stops and durations, the transit server is able to match advertisement profiles to provide advertisements that are most relevant to a user and most likely to be taken advantage of based on the user's location and ability to visit an establishment. A relevant advertisement may be provided to a user prior to arriving at a transit stop or the destination, such that a user has time to notice the advertisement and to decide to visit the establishment. In some embodiments, if the duration of the transit stop is too short, no advertisement will be provided. Real-time arrival time information may be provided to the mobile device at block 410. The real-time arrival time information may be based at least in part on the vehicle location information and the destination information. Some embodiments may incorporate real-time and/or historical traffic data to further increase the accuracy of the predicted arrival times.

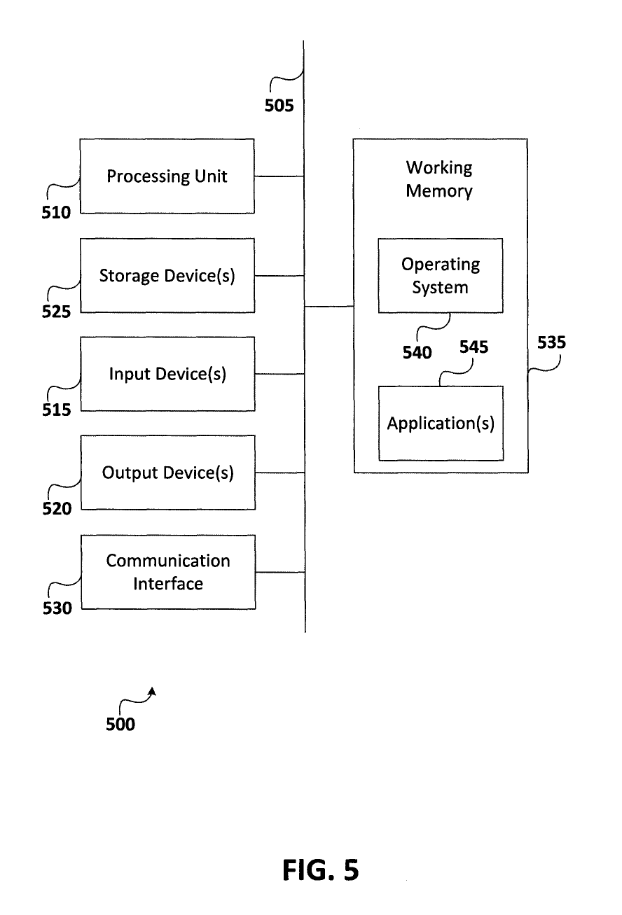

A computer system as illustrated in FIG. 5 may be incorporated as part of the previously described computerized devices. For example, computer system 500 can represent some of the components of the transit server 100, mobile device 102, and/or advertising service 108, and/or electronic billboard 110 of FIG. 1, as well as transit server 300, mobile device 302, and/or advertising service 306 of FIG. 3. FIG. 5 provides a schematic illustration of one embodiment of a computer system 500 that can perform the methods provided by various other embodiments, as described herein, and/or can function as the host computer system, a remote kiosk/terminal, a point-of-sale device, a mobile device, and/or a computer system. FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include a processing unit 510, including without limitation one or more general-purpose processors and/or one or more special-purpose processors (such as digital signal processing chips, graphics acceleration processors, and/or the like); one or more input devices 515, which can include without limitation a mouse, a keyboard, a touchscreen, receiver, a motion sensor, a camera, a smartcard reader, a contactless media reader, and/or the like; and one or more output devices 520, which can include without limitation a display device, a speaker, a printer, a writing module, and/or the like.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 500 might also include a communication interface 530, which can include without limitation a modem, a network card (wireless or wired), an infrared communication device, a wireless communication device and/or chipset (such as a Bluetooth® device, an 502.11 device, a WiFi device, a WiMax device, an NFC device, cellular communication facilities, etc.), and/or similar communication interfaces. The communication interface 530 may permit data to be exchanged with a network (such as the network described below, to name one example), other computer systems, and/or any other devices described herein. In many embodiments, the computer system 500 will further comprise a non-transitory working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 510, applications 545, etc.) Further, connection to other computing devices such as network input/output devices may be employed.

Some embodiments may employ a computer system (such as the computer system 500) to perform methods in accordance with the disclosure. For example, some or all of the procedures of the described methods may be performed by the computer system 500 in response to processing unit 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processing unit 510 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processing unit 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 525. Volatile media include, without limitation, dynamic memory, such as the working memory 535. Transmission media include, without limitation, coaxial cables, copper wire and fiber optics, including the wires that comprise the bus 505, as well as the various components of the communication interface 530 (and/or the media by which the communication interface 530 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a non-transitory storage device 525 either before or after execution by the processing unit 510.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

What is claimed is:

1. A method for providing real-time location-based product and service suggestions within a transit system, the method comprising:
receiving origin information and destination information, wherein both the origin information and the destination information are related to a user's trip using the transit system;
receiving device location information from a mobile device and vehicle location information from a transit vehicle, wherein the device location information comprises a location of the mobile device, and wherein the vehicle location information comprises a location of the transit vehicle;
matching an advertisement profile with one or more of the device location information, the vehicle location information, the original information, or the destination information to identify an advertisement;
causing a display of a remote device to reproduce an electronic version of the identified advertisement; and
providing real-time arrival time information to the mobile device, wherein the real-time arrival time information is based at least in part on the vehicle location information and the destination information.

2. The method for providing real-time location-based product and service suggestions within a transit system according to claim 1, wherein:
the remote device comprises one or more selected from the mobile device, an electronic billboard, or an electronic sign on the transit vehicle.

3. The method for providing real-time location-based product and service suggestions within a transit system according to claim 1, further comprising:
receiving demographic information related to the user, wherein matching the advertisement profile is based at least in part on the demographic information.

4. The method for providing real-time location-based product and service suggestions within a transit system according to claim 3, wherein:
receiving demographic information comprises one or more of enrolling the user in the transit system or linking a third-party account to a transit system account associated with the origin information and destination information.

5. The method for providing real-time location-based product and service suggestions within a transit system according to claim 1, wherein:
the location of the mobile device is determined by a global positioning satellite (GPS) sensor of the mobile device; and
the location of the transit vehicle is determined by one or more of a GPS sensor of the transit vehicle or signals from one or more beacons of the transit system.

6. The method for providing real-time location-based product and service suggestions within a transit system according to claim 1, wherein:
the origin information and destination information are received when a user plans a trip or purchases transit fare.

7. The method for providing real-time location-based product and service suggestions within a transit system according to claim 1, further comprising:
detecting a next transit stop and a duration of the next transit stop, wherein the advertisement profile further matches the next transit stop and the duration.

8. A non-transitory computer-readable medium having instructions embedded thereon for providing real-time location-based product and service suggestions within a transit system, the instructions comprising computer code for causing a computing device to:
receive origin information and destination information, wherein both the origin information and the destination information are related to a user's trip using the transit system;
receive device location information from a mobile device and vehicle location information from a transit vehicle, wherein the device location information comprises a location of the mobile device, and wherein the vehicle location information comprises a location of the transit vehicle;
match an advertisement profile with one or more of the device location information, the vehicle location information, the original information, or the destination information to identify an advertisement;
cause a display of a remote device to reproduce an electronic version of the identified advertisement; and
provide real-time arrival time information to the mobile device, wherein the real-time arrival time information is based at least in part on the vehicle location information and the destination information.

9. The non-transitory computer-readable medium of claim 8, wherein:
the remote device comprises one or more selected from the mobile device, an electronic billboard, or an electronic sign on the transit vehicle.

10. The non-transitory computer-readable medium of claim 8, further comprising instructions for causing the computing device to:
receive demographic information related to the user, wherein matching the advertisement profile is based at least in part on the demographic information.

11. The non-transitory computer-readable medium of claim 10, wherein:
receiving demographic information comprises one or more of enrolling the user in the transit system or linking a third-party account to a transit system account associated with the origin information and destination information.

12. The non-transitory computer-readable medium of claim 8, wherein:
the location of the mobile device is determined by a global positioning satellite (GPS) sensor of the mobile device; and
the location of the transit vehicle is determined by one or more of a GPS sensor of the transit vehicle or signals from one or more beacons of the transit system.

13. The non-transitory computer-readable medium of claim 8, wherein:
the origin information and destination information are received when a user plans a trip or purchases transit fare.

14. The non-transitory computer-readable medium of claim 8, further comprising instructions for causing the computing device to:
detect a next transit stop and a duration of the next transit stop, wherein the advertisement profile further matches the next transit stop and the duration

15. A system for providing real-time location-based product and service suggestions within a transit system, comprising:
a communications interface configured to send and receive data;
a memory; and
a processor configured to:
receive origin information and destination information, wherein both the origin information and the destination information are related to a user's trip using the transit system;
receive device location information from a mobile device and vehicle location information from a transit vehicle, wherein the device location information comprises a location of the mobile device, and wherein the vehicle location information comprises a location of the transit vehicle;
match an advertisement profile with one or more of the device location information, the vehicle location information, the original information, or the destination information to identify an advertisement;
cause a display of a remote device to reproduce an electronic version of the identified advertisement; and
provide real-time arrival time information to the mobile device, wherein the real-time arrival time information is based at least in part on the vehicle location information and the destination information.

16. The system for providing real-time location-based product and service suggestions within a transit system of claim 15, wherein:
the remote device comprises one or more selected from the mobile device, an electronic billboard, or an electronic sign on the transit vehicle.

17. The system for providing real-time location-based product and service suggestions within a transit system of claim 15, wherein the processor is further configured to:
receive demographic information related to the user, wherein matching the advertisement profile is based at least in part on the demographic information.

18. The system for providing real-time location-based product and service suggestions within a transit system of claim 17, wherein:
receiving demographic information comprises one or more of enrolling the user in the transit system or linking a third-party account to a transit system account associated with the origin information and destination information.

19. The system for providing real-time location-based product and service suggestions within a transit system of claim 15, wherein:
the origin information and destination information are received when a user plans a trip or purchases transit fare

20. The system for providing real-time location-based product and service suggestions within a transit system of claim 15, wherein the processor is further configured to:
detect a next transit stop and a duration of the next transit stop, wherein the advertisement profile further matches the next transit stop and the duration.
